(19) United States
(12) Patent Application Publication
(10) Pub. No.: US 2025/0347542 A1
(43) Pub. Date: Nov. 13, 2025

(54) POSITIONING DEVICE

(71) Applicant: ALPS ALPINE CO., LTD., Tokyo (JP)

(72) Inventors: Hiroki KANAYA, Tokyo (JP); Akihiro KUSAKA, Miyagi (JP); Hiroshi YOSHIDA, Miyagi (JP); Shun MIYAZAKI, Miyagi (JP)

(21) Appl. No.: 19/271,993

(22) Filed: Jul. 17, 2025

Related U.S. Application Data
(63) Continuation of application No. PCT/JP2023/045682, filed on Dec. 20, 2023.

(30) Foreign Application Priority Data
Jan. 30, 2023 (JP) 2023-012087

(51) Int. Cl. G01D 11/30; G01D 5/14; G01D 13/22

(52) U.S. Cl. CPC G01D 11/30; G01D 5/145; G01D 13/22

(57) ABSTRACT

A positioning device includes a body to be disposed to face a surface of a cover; a plurality of slides provided, in the body, to be movable in different directions along a radial direction of the cover; a plurality of claws provided at tips of the plurality of slides and configured to hold an outer circumferential surface of an analog meter; a synchronizing driver configured to move the plurality of slides in the radial direction in synchronization with each other such that distances of the plurality of claws from a center of the body are always equal to each other; a sensor holder provided at a center of a surface of the body facing the surface of the cover, and configured to hold the sensor; and a pusher configured to push the sensor held by the sensor holder toward a center of the surface of the cover facing the sensor.

### CROSS-REFERENCE TO RELATED APPLICATIONS

This application is a continuation application of International Application No. PCT/JP2023/045682, filed on Dec. 20, 2023, and designated the U.S., which is based upon and claims priority to Japanese Patent Application No. 2023-012087, filed on Jan. 30, 2023, the entire contents of which are incorporated herein by reference.

### BACKGROUND

### 1. Field of the Invention

The present disclosure relates to a positioning device.

### 2. Description of the Related Art

Japanese Laid-Open Patent Application Publication No. 2021-196250 discloses a positioning device configured to hold an outer circumferential surface of an outer frame of a cover of an analog meter by a pair of holding members, and position a magnetic sensor at the center of a plurality of types of meters having different outer diameters.

### SUMMARY

A positioning device according to an aspect of the present disclosure is configured to position a sensor at a center of a surface of a substantially circular and transparent cover that covers a display surface of an analog meter. The positioning device includes: a body to be disposed to face the surface of the cover upon positioning the sensor; a plurality of slides that are provided, in the body, to be movable in different directions along a radial direction of the cover; a plurality of claws that are provided at tips of the plurality of slides and configured to hold an outer circumferential surface of the analog meter; a synchronizing driver that is configured to move the plurality of slides in the radial direction in synchronization with each other such that distances of the plurality of claws from a center of the body are always equal to each other; a sensor holder that is provided at a center of a surface of the body facing the surface of the cover, and configured to hold the sensor; and a pusher configured to push the sensor held by the sensor holder toward the center of the surface of the cover facing the sensor.

### BRIEF DESCRIPTION OF THE DRAWINGS

FIG. 1 is an external perspective view of a positioning device according to an embodiment of the present disclosure, as viewed from above;

FIG. 2 is an external perspective view of the positioning device according to the embodiment, as viewed from below;

FIG. 3 is a cross-sectional view of the positioning device according to the embodiment;

FIG. 4 is an exploded perspective view of the positioning device according to the embodiment, as viewed from above;

FIG. 5 is an exploded perspective view of the positioning device according to the embodiment, as viewed from below;

FIG. 6 is an external perspective view of a synchronizing driver included in the positioning device according to the embodiment;

FIG. 7 is a view illustrating a state in which the positioning device according to the embodiment holds an analog meter;

FIG. 8 is an external perspective view illustrating an example in which a sensor according to an embodiment of the present disclosure is disposed at the analog meter; and

FIG. 9 is a view illustrating an example in which the sensor according to the embodiment is disposed at the analog meter.

### DETAILED DESCRIPTION OF THE DISCLOSURE

The technique disclosed in Japanese Laid-Open Patent Application Publication No. 2021-196250 necessitates detachment of the cover from the analog meter for attaching the magnetic sensor to the cover. This is laborious work for operators.

Hereinafter, embodiments of the present disclosure will be described with reference to the drawings.

### (Configuration of Positioning Device 100)

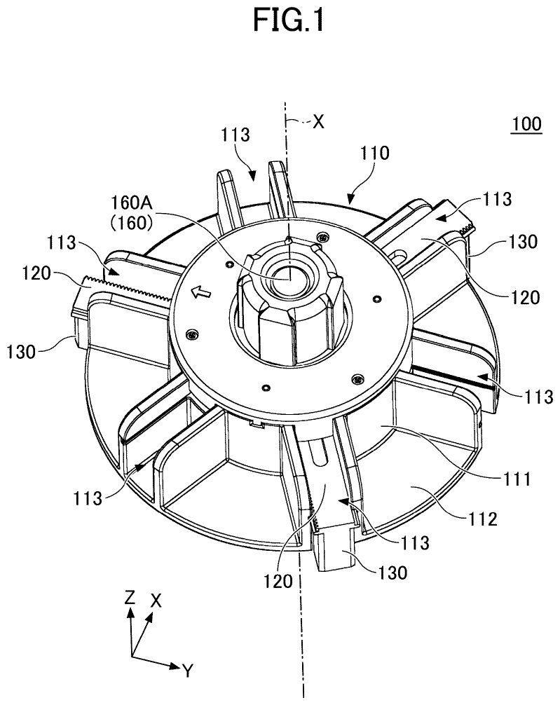

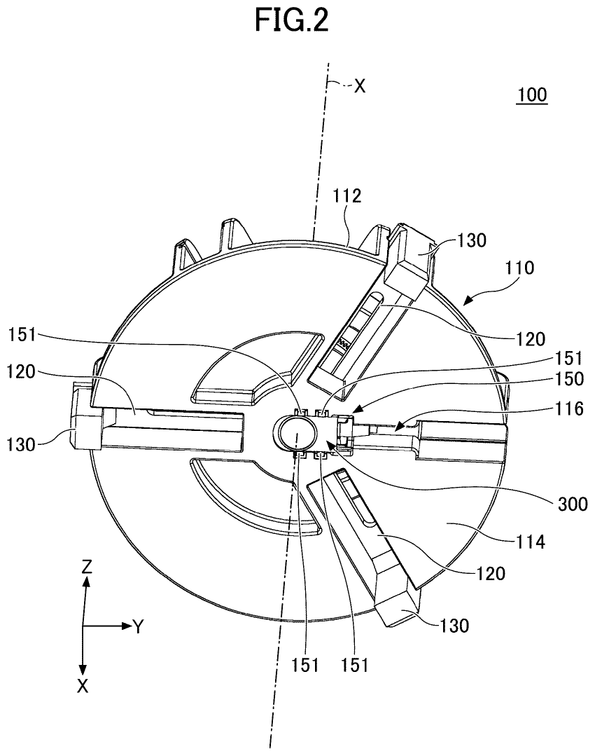

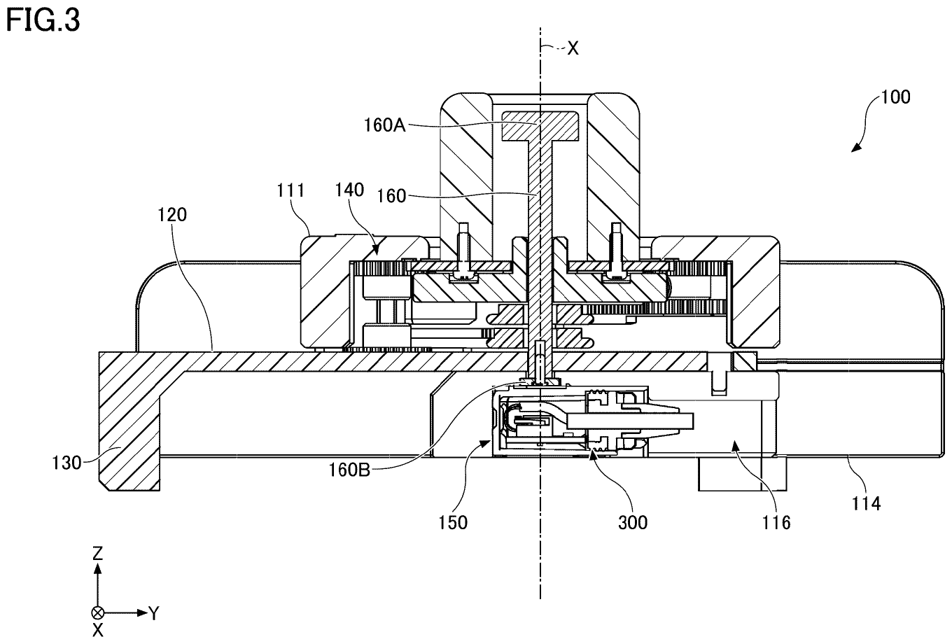

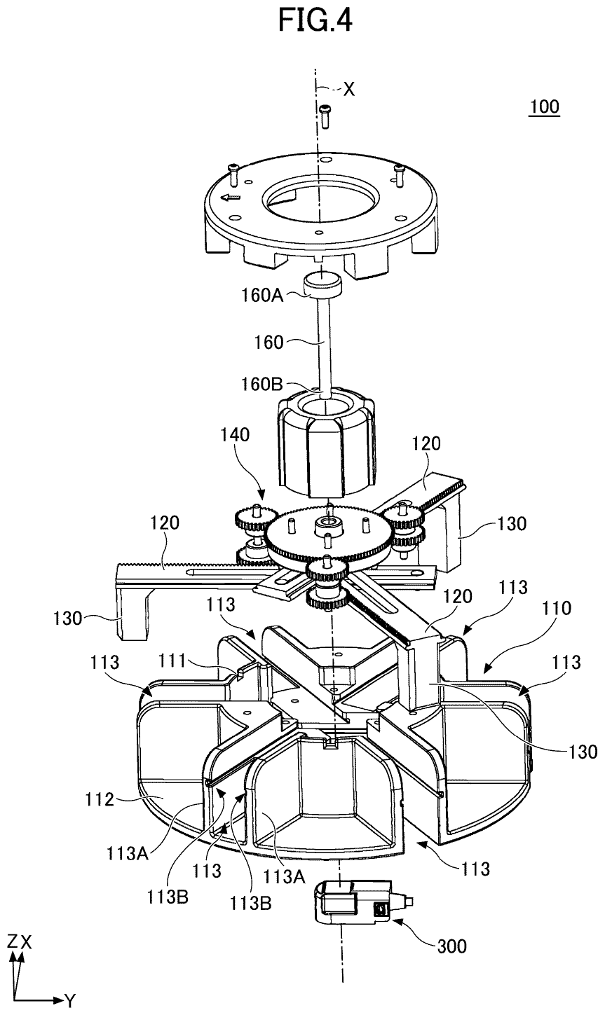

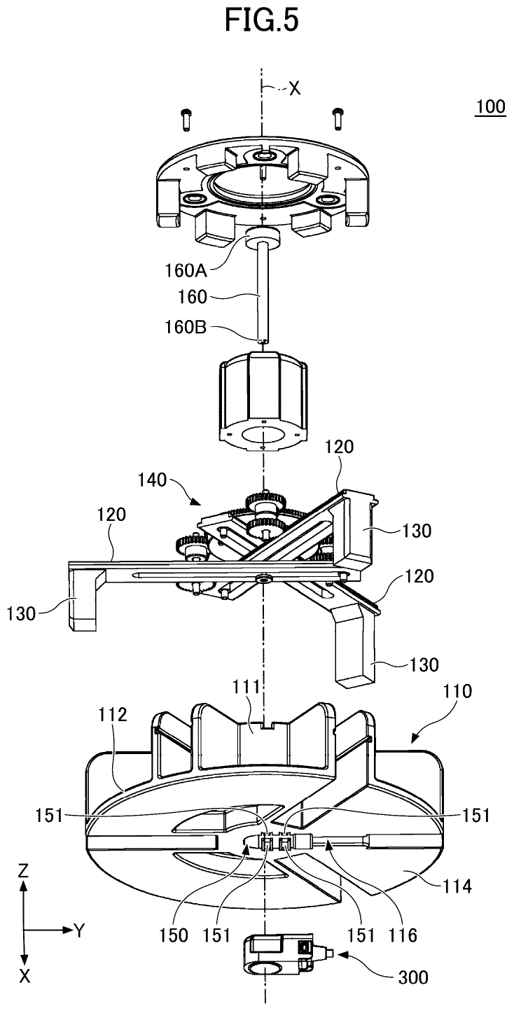

FIG. 1 is an external perspective view of a positioning device 100 according to an embodiment of the present disclosure, as viewed from above. FIG. 2 is an external perspective view of the positioning device 100 according to the embodiment, as viewed from below. FIG. 3 is a cross-sectional view of the positioning device 100 according to the embodiment. FIG. 4 is an exploded perspective view of the positioning device 100 according to the embodiment, as viewed from above. FIG. 5 is an exploded perspective view of the positioning device 100 according to the embodiment, as viewed from below.

In the following description, for the sake of convenience, a direction orthogonal to a surface 210A of a glass cover 210 of an analog meter 200 is referred to as a vertical direction (Z-axis direction). The surface 210A side of the glass cover 210 is referred to as an upper side (positive Z-axis side), and the rear surface side of the glass cover 210 is referred to as a lower side (negative Z-axis side). Also, directions parallel to the surface 210A of the glass cover 210 and orthogonal to each other are referred to as an X-axis direction and a Y-axis direction.

The positioning device 100 illustrated in FIG. 1 is a device configured to position a sensor 300 at the center of the surface 210A of the substantially circular and transparent glass cover 210 (an example of “cover”) that covers a display surface of the analog meter 200.

As illustrated in FIG. 1, the positioning device 100 includes a body 110, three slides 120, three claws 130, a synchronizing driver 140, a sensor holder 150, and a pusher 160. These components included in the positioning device 100 are formed using any relatively hard materials (e.g., resins, metals, and the like).

### <Body 110>

When the sensor 300 is to be positioned, the bottom surface of the body 110 is disposed to face the surface of the glass cover 210. The body 110 holds the components included in the positioning device 100, i.e., the three sliding members 120, the synchronizing driver 140, and the pusher 160.

Specifically, the body 110 includes a base 111 and an outer circumferential portion 112. The base 111 is a substantially cylindrical portion having a center on a center axis X and extending in the vertical direction along the center axis X. The outer circumferential portion 112 is an annular and horizontal (i.e., parallel to an XY plane) flat-plate portion that is connected to the lower end of the outer circumferential surface of the base 111 and encloses the base 111.

The body 110 includes six guides 113 provided at equiangular intervals (i.e., at 60° intervals). The guides 113 are provided at the outer circumferential portion 112 along the radial direction of the body 110 from openings formed in the outer circumferential wall of the base 111.

As illustrated in FIG. 4, each guide 113 includes a pair of walls 113A that are vertically provided on the outer circumferential portion 112. When the slide 120 is disposed between the pair of walls 113A, the guide 113 guides a sliding movement of the slide 120 in the radial direction.

As illustrated in FIG. 4, each of the pair of walls 113A includes a support groove 113B extending in the radial direction of the body 110 (i.e., the sliding direction of the slide 120) and supporting a widthwise end of the slide 120. The support groove 113B can guide a sliding movement of the slide 120 in the radial direction of the body 110, and maintain the slide 120 to be horizontal.

### <Slides 120>

The three slides 120 are each a long plate extending in a straight line in the radial direction of the body 110. The three slides 120 are provided to be slidable along the radial direction of the body 110.

Specifically, when the three slides 120 are each disposed between the pair of walls 113A included in the guide 113 of the body 110, each slide 120 is supported by the pair of walls 113A to be slidable along the radial direction of the body 110.

The three slides 120 are disposed at equiangular intervals (i.e., at 120° intervals) with respect to the body 110. That is, the three slides 120 are provided in the body 110 to be slidable in three different radial directions.

Also, for each of the three slides 120, the rear end of the slide 120 extends in the radial direction opposite to the radial direction in which the front end of the slide 120 extends (i.e. the radial direction differing by 180°). That is, each of the three slides 120 is provided to extend over a pair of the guides 113 forming a straight line (i.e., 1800 different in the radial direction) so as to cross the center axis X.

The three slides 120 are provided to cross each other at a position at which they overlap with the center of the body 110 in a plan view (i.e. on the center axis X), and are stacked on top of each other in the vertical direction (Z-axis direction). Thus, the sliding movements of the three slides 120 do not interfere with each other.

### <Claws 130>

The three claws 130 are provided at the tips of the corresponding three slides 120 to project downward from the tips. Thus, the three claws 130 move in the radial direction of the body 110 along with the three slides 120. The three claws 130 can hold the outer circumferential surface of the analog meter 200 by contacting the outer circumferential surface of the analog meter 200 (an outer circumferential surface 212A of an outer frame 212 of the glass cover 210) at the surfaces of the three claws 130 facing the center axis X.

### <Synchronizing Driver 140>

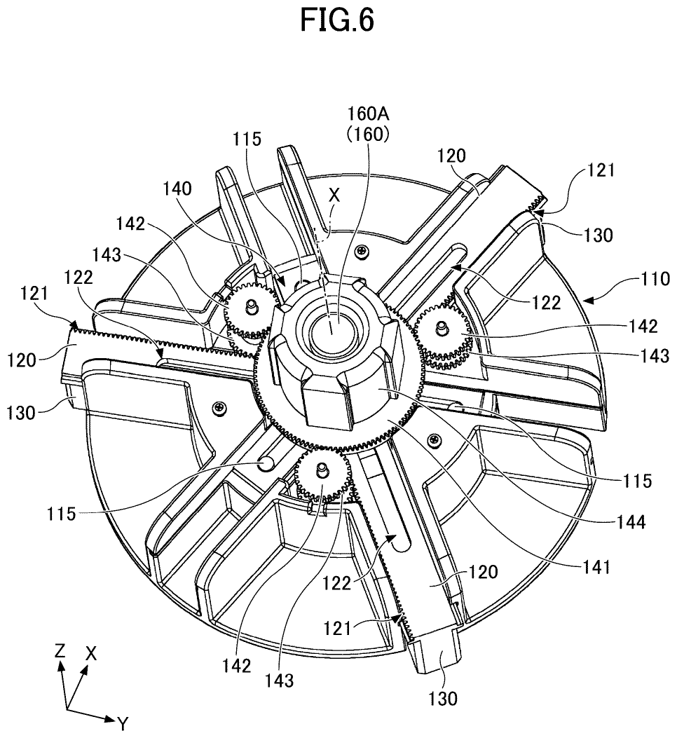

The synchronizing driver 140 is provided inside the base 111 of the body 110. The synchronizing driver 140 is configured to move the three slides 120 in the radial direction of the body 110 in synchronization with each other such that the distances of the three claws 130 from the center of the body 110 (i.e., the distances of the three claws 130 from the center axis X) are always equal to each other (i.e., the three claws 130 are always positioned on the same circumference). A detailed configuration and operations of the synchronizing driver 140 will be described with reference to FIG. 6.

### <Sensor Holder 150>

The sensor holder 150 is provided at the center of a bottom surface 114 of the body 110 (i.e., on a rotation axis X of a surface of the body 110 facing the surface 210A of the glass cover 210 included in the analog meter 200), and is configured to hold the sensor 300. Specifically, the sensor holder 150 has a shape that is substantially the same as the outer shape of the sensor 300 and that is recessed upward (positive Z-axis direction) from the bottom surface 114 of the body 110.

When the sensor holder 150 receives the sensor 300, the sensor holder 150 can hold the sensor 300 in a state in which the center of the body 110 (i.e., the center axis X) coincides with the center of the sensor 300.

A plurality of claws 151 forming a snap-fit structure are provided inside the sensor holder 150. In the present embodiment, as an example, two pairs of claws 151 facing each other are provided. When the sensor 300 is completely pushed into the sensor holder 150, the plurality of claws 151 are engaged with the bottom surface of the sensor 300, thereby enabling suppression of falling of the sensor 300 out of the sensor holder 150.

The plurality of claws 151 are each elastically deformable such that the gap between the pair of claws 151 facing each other becomes widened when the sensor 300 is pushed into the sensor holder 150 from below. Thus, the plurality of claws 151 can readily and surely hold the sensor 300.

Also, the plurality of claws 151 are elastically deformable such that the gap between the pair of claws 151 facing each other becomes widened when the sensor 300 is pushed downward by the pusher 160. Thus, the plurality of claws 151 release the engagement with the sensor 300, and can readily push the sensor 300 from the sensor holder 150. For example, a piece of double-sided tape is attached to the bottom surface of the sensor 300 facing the surface 210A of the glass cover 210. When the sensor 300 is pushed out from the sensor holder 150 by the pusher 160, the sensor 300 is attached and fixed to the surface 210A of the glass cover 210 with the double-sided tape.

The bottom surface 114 of the body 110 is provided with a groove 116 radially extending in a straight line from the sensor holder 150 to the outer circumferential portion of the body 110. Thus, according to the positioning device 100 according to the embodiment, when a cable 303 included in the sensor 300 is fitted into the groove 116, it is possible to draw the cable 303 outward of the body 110 without causing the cable 303 to project downward from the bottom surface 114 of the body 110. Therefore, according to the positioning device 100 according to the embodiment, when disposing the bottom surface 114 of the body 110 to be parallel to the surface 210A of the glass cover 210, it is possible to prevent the cable 303 from becoming an obstacle.

### <Pusher 160>

The pusher 160 is a rod-like member extending in the vertical direction (Z-axis direction) along the rotation axis X at the center of the body 110 (i.e. on the rotation axis X). The pusher 160 is provided to penetrate through an operating knob 144, a driving gear 141, and the three slides 120, and is movable in the vertical direction (Z-axis direction). A lower end 160B of the pusher 160 penetrates through a ceiling of the sensor holder 150, and is exposed inside the sensor holder 150.

With this configuration, when an upper end 160A of the pusher 160 is pushed downward by an operator, the pusher 160 is moved downward, and thus the lower end 160B of the pusher 160 can push the sensor 300 held by the sensor holder 150 toward the center of the surface 210A of the glass cover 210 facing the sensor 300.

### (Detailed Configuration and Operations of Synchronizing Driver 140)

FIG. 6 is an external perspective view of the synchronizing driver 140 included in the positioning device 100 according to the embodiment. FIG. 6 illustrates the body 110 and the three slides 120 along with the synchronizing driver 140.

As illustrated in FIG. 6, each slide 120 includes a rack 121 formed at an edge of the slide 120 along the moving direction of the slide 120 (i.e., the radial direction of the body 110).

As illustrated in FIG. 6, the synchronizing driver 140 includes a driving gear 141, three driven gears 142 provided for each slide 120, three pinion gears 143 provided for each slide 120, and the operating knob 144.

The driving gear 141 is provided at the center of the body 110 (i.e. on the center axis X) to be rotatable about the center axis X.

The three driven gears 142 are provided to mesh with the driving gear 141 at the circumference of the driving gear 141.

The three pinion gears 143 are provided below (on the negative Z-axis side of) the three corresponding driven gears 142, and rotate integrally with the three corresponding driven gears 142. The three pinion gears 143 each mesh with the rack 121 of the slide 120.

The operating knob 144 is a member to be rotated by an operator. The operating knob 144 is fixedly attached to the top surface of the driving gear 141, and has a substantially cylindrical shape. However, the outer circumferential surface of the operating knob 144 is provided with projections and recesses for facilitating gripping by an operator.

As illustrated in FIG. 6, the rod-like pusher 160 extending in the vertical direction (Z-axis direction) along the rotation axis X is provided on the rotation axis X to penetrate through the operating knob 144, the driving gear 141, and the three slides 120.

In the synchronizing driver 140 configured as described above, when an operator rotates the operating knob 144 counterclockwise as viewed from above (positive Z-axis direction), the driving gear 141 is rotated counterclockwise along with the operating knob 144. By this, the three driven gears 142 and the three pinion gears 143 are rotated clockwise. As a result, the three slides 120 move outward in the radial direction of the body 110 in synchronization with each other. That is, the three claws 130 move outward in the radial direction of the body 110 in synchronization with each other. Therefore, the three claws 130 gradually increase the radius of an imaginary circle centered on the rotation axis X while maintaining the three claws 130 at positions on the same circumference of the imaginary circle.

Conversely, in the synchronizing driver 140 configured as described above, when an operator rotates the operating knob 144 clockwise as viewed from above (positive Z-axis direction), the driving gear 141 is rotated clockwise along with the operating knob 144. By this, the three driven gears 142 and the three pinion gears 143 are rotated counterclockwise. As a result, the three slides 120 move inward in the radial direction of the body 110 in synchronization with each other. That is, the three claws 130 move inward in the radial direction of the body 110 in synchronization with each other. Therefore, the three claws 130 gradually decrease the radius of an imaginary circle centered on the rotation axis X while maintaining the three claws 130 at positions on the same circumference of the imaginary circle.

As illustrated in FIG. 6, each slide 120 includes a slit 122 formed in a straight line along the sliding direction of the slide 120. The pusher 160 is inserted through the slit 122 in a state in which the pusher 160 penetrates through the operating knob 144 and the driving gear 141 on the rotation axis X. Thus, each slide 120 can slide in the radial direction from the pusher 160 (the rotation axis X) without hindering the vertical movement of the pusher 160. Also, a cylindrical pin 115 is disposed in the slit 122. The cylindrical pin 115 is provided, in the guide 113 of the body 110, to project upward from the bottom surface of the guide 113. In accordance with the sliding movement of the slide 120, the pin 115 slides in the slit 122. When an amount of the sliding movement of the slide 120 reaches a predetermined maximum amount, the pin 115 contacts the rear end of the slit 122, thereby restricting any further movement of the slide 120 and preventing the slide 120 from falling out of the guide 113.

### (Positioning Method of Sensor 300)

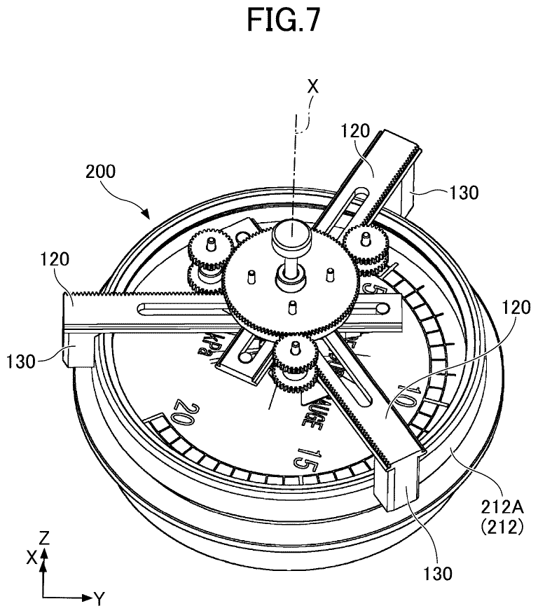

Next, a positioning method of the sensor 300 using the positioning device 100 according to the embodiment will be described with reference to FIG. 7. FIG. 7 is a view illustrating a state in which the positioning device 100 according to the embodiment holds the analog meter 200. In FIG. 7, for ease of understanding of the holding state of the analog meter 200, some of the parts of the positioning device 100 are not illustrated.
(1) First, an operator fits the sensor 300 into the sensor holder 150 formed at the bottom surface 114 of the body 110 included in the positioning device 100. The sensor 300 is held by the plurality of claws 151 included in the sensor holder 150 such that the sensor 300 does not readily fall out of the sensor holder 150. Then, the operator fits the cable 303 included in the sensor 300 into the groove 116 formed in the bottom surface 114 of the body 110. Also, the operator peels off a release paper sheet of the double-sided tape attached to the bottom surface of a sensor casing 301 included in the sensor 300 held in the sensor holder 150.
(2) Next, the operator rotates the operating knob 144 counterclockwise as viewed from above (positive Z-axis direction) to move the three slides 120 outward in the radial direction in synchronization with each other, thereby moving the three claws 130 outward in the radial direction in synchronization with each other to form, inward of the three claws 130, a space for disposing the outer circumferential portion of the analog meter 200 (the outer circumferential surface 212A of the outer frame 212 of the glass cover 210).
(3) Next, the operator disposes the bottom surface 114 of the body 110 included in the positioning device 100 to face in parallel to the surface 210A of the glass cover 210 included in the analog meter 200, thereby disposing the outer circumferential portion of the analog meter 200 (the outer circumferential surface 212A of the outer frame 212 of the glass cover 210) in the space formed inward of the three claws 130.
(4) Next, the operator rotates the operating knob 144 clockwise as viewed from above (positive Z-axis direction) to move the three slides 120 inward in the radial direction in synchronization with each other, thereby moving the three claws 130 inward in the radial direction in synchronization with each other. By this, as illustrated in FIG. 7, the three claws 130 hold the outer circumferential portion of the analog meter 200 (the outer circumferential surface 212A of the outer frame 212 of the glass cover 210). Thus, the center of the body 110 (i.e., the center axis X) coincides with the center of the surface 210A of the glass cover 210. At the same time, the center of the sensor 300 held by the sensor holder 150 coincides with the center of the surface 210A of the glass cover 210.
(5) Next, the operator pushes the pusher 160 of the positioning device 100 downward, thereby pushing the sensor 300 downward from the sensor holder 150. Thus, the sensor 300 is pushed onto the surface 210A of the glass cover 210 in a state in which the center of the sensor 300 coincides with the center of the surface 210A of the glass cover 210. By the adhesive force of the double-sided tape, the sensor 300 is fixed to the surface 210A of the glass cover 210.
(6) Then, the operator rotates the operating knob 144 counterclockwise as viewed from above (positive Z-axis direction) to move the three slides 120 outward in the radial direction in synchronization with each other, thereby moving the three claws 130 outward in the radial direction in synchronization with each other and releasing the outer circumferential portion of the analog meter 200 (the outer circumferential surface 212A of the outer frame 212 of the glass cover 210) from the holding by the three claws 130. Finally, the positioning device 100 is removed from the analog meter 200.

Through the above procedure, positioning of the sensor 300 is completed. This positioning fixes the sensor 300 to the surface 210A of the glass cover 210 in a state in which the center of the surface 210A of the glass cover 210 of the analog meter 200 coincides with the center of the sensor 300.

For positioning the sensor 300, just by performing simple operations, such as rotating the operating knob 144 and pushing the pusher 160, the operator can fix the sensor 300 to the surface 210A of the glass cover 210 in a state in which the center of the surface 210A of the glass cover 210 of the analog meter 200 coincides with the center of the sensor casing 301.

### (Disposition Example of Sensor 300)

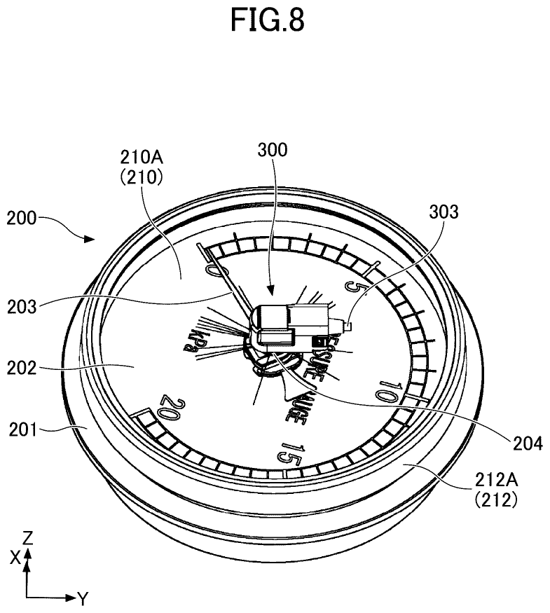

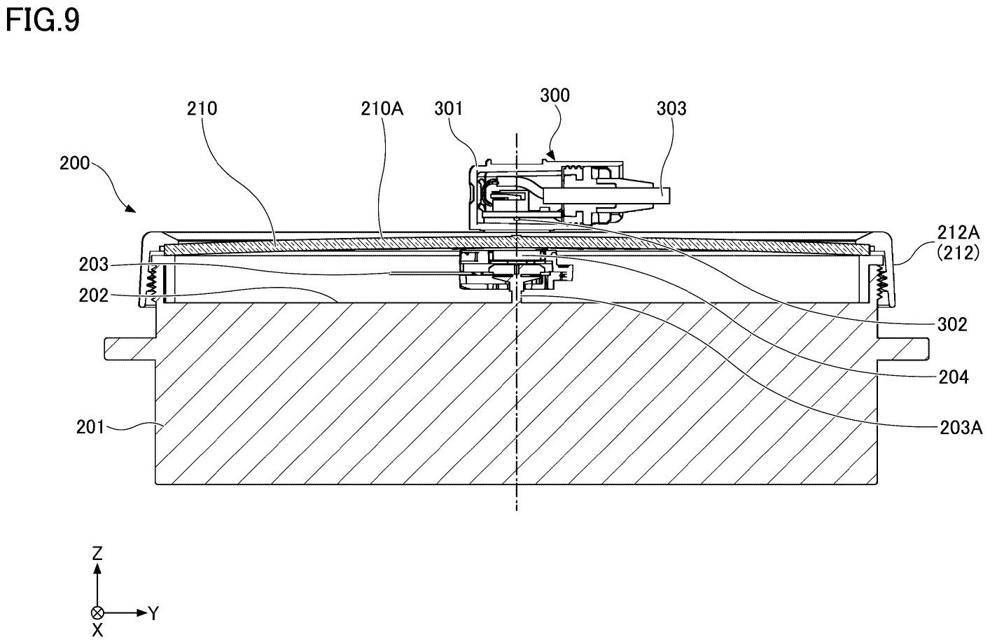

FIG. 8 is an external perspective view illustrating an example in which the sensor 300 according to the embodiment is disposed at the analog meter 200. FIG. 9 is a view illustrating an example in which the sensor 300 according to the embodiment is disposed at the analog meter 200.

The analog meter 200 illustrated in FIGS. 8 and 9 is, for example, a water meter, a power meter, a gas meter, or the like. As illustrated in FIGS. 8 and 9, the analog meter 200 includes a casing 201, a display surface 202, a pointer 203, a magnet 204, a glass cover 210, and the outer frame 212. The casing 201 is a cylindrical member that forms the outer shape of the analog meter 200, and has a closed bottom surface. The display surface 202 is a horizontal surface that is provided inside the casing 201, and faces the space above the analog meter 200. The display surface 202 has a circular shape in a plan view. Scales representing various measurements stepwise are printed on the display surface 202 to be successive along the circumferential direction. The pointer 203 has a rotation axis 203A, and rotates about the rotation axis 203A to point to a scale printed on the display surface 202 in accordance with the measurement. The magnet 204 has a disk shape, and is attached to the rotation center of the pointer 203. In a plan view, the magnet 204 is magnetized to an N pole and an S pole with a boundary being a boundary line passing through the center of the magnet 204. The glass cover 210 is an example of “substantially circular and transparent cover”, and is a transparent and disk-shaped glass member covering the display surface 202. The “substantially circular and transparent cover” is not limited to the glass cover, but may be a resin cover. The outer frame 212 is a circular frame-shaped member, and is fitted and attached to the edge of an opening above (on the positive Z-axis side of) the casing 201. The outer frame 212 holds the outer circumferential portion of the glass cover 210 disposed inside the outer frame 212.

By use of the positioning device 100, as illustrated in FIGS. 8 and 9, the sensor 300 is attached at the center of the surface 210A of the glass cover 210 included in the analog meter 200 (i.e., the rotation center of the pointer 203). The internal configuration of the sensor 300 is illustrated in FIG. 9. The sensor 300 includes a magnetic sensor 302 provided, at the center in the sensor casing 301, to face the analog meter 200 (negative Z-axis side). When the sensor 300 is attached at the center of the surface 210A of the glass cover 210, the magnetic sensor 302 faces the magnet 204 attached at the rotation center of the pointer 203 of the analog meter 200. Thus, the magnetic sensor 302 can magnetically detect the rotation angle of the pointer 203. Then, the sensor 300 transmits, to the exterior through the cable 303, a rotation angle detection signal indicating the rotation angle of the pointer 203 detected by the magnetic sensor 302. For example, the sensor 300 continuously detects the rotation angle of the pointer 203 at intervals of predetermined time (e.g., at intervals of n seconds), and continuously transmits the rotation angle detection signal to the exterior at intervals of predetermined time (e.g., at intervals of n seconds).

For example, the sensor 300 transmits the rotation angle detection signal to a wireless communication device (not shown). The wireless communication device transmits the received rotation angle detection signal to a rotation angle transmitter (not shown). The rotation angle transmitter performs predetermined processes (e.g., displaying the rotation angle on a monitor, abnormality detection, recording, data transmission to other devices, and the like) using the rotation angle of the pointer 203 indicated by the received rotation angle detection signal. For example, the rotation angle transmitter transmits the rotation angle detection signal indicating the detected rotation angle to a gateway or cloud through wireless communication (e.g., BLUETOOTH (registered trademark) wireless communication, SIGFOX (registered trademark) wireless communication, or the like).

As described above, the positioning device 100 according to the embodiment is the positioning device 100 configured to position the sensor at the center of the surface 210A of the substantially circular and transparent glass cover 210 that covers the display surface of the analog meter 200. The positioning device 100 includes: the body 110 to be disposed to face the surface 210A of the glass cover 210 upon positioning the sensor 300; the plurality of slides 120 that are provided, in the body 110, to be movable in different directions along the radial direction of the glass cover 210; the plurality of claws 130 that are provided at the tips of the plurality of slides 120 and configured to hold the outer circumferential surface of the analog meter 200; the synchronizing driver 140 that is configured to move the plurality of slides 120 in the radial direction in synchronization with each other such that the distances of the plurality of claws 130 from the center of the body 110 are always equal to each other; the sensor holder 150 that is provided at the center of the surface of the body 110 facing the surface 210A of the glass cover 210, and configured to hold the sensor 300; and the pusher 160 configured to push the sensor 300 held by the sensor holder 150 toward the center of the surface 210A of the glass cover 210 facing the sensor 300.

With this configuration, just by moving the plurality of slides 120 in the radial direction in synchronization with each other and holding the outer circumferential surface of the analog meter 200 by the plurality of claws 130, the positioning device 100 according to the embodiment can position the sensor 300 at the center of the surface 210A of the glass cover 210 of the analog meter 200 of any types having different outer diameters, without removing the glass cover 210 from the analog meter 200.

Further, by pushing the sensor 300 out of the sensor holder 150 using the pusher 160, the positioning device 100 according to the embodiment can fix the sensor 300 to the surface 210A of the glass cover 210 with the double-sided tape or the like in a state in which the sensor 300 is positioned at the center of the surface 210A of the glass cover 210.

Therefore, according to the positioning device 100 according to the embodiment, it is possible to readily position the sensor 300 at the center of the glass cover 210 included in the analog meter 200 of any types having different outer diameters.

The embodiments of the present invention have been described above in detail. However, the present invention is not limited to the embodiments as described above. Various modifications or alterations are possible without departing from the scope of the present invention as recited in claims.

For example, in the positioning device 100 according to the embodiment, each of the plurality of slides 120 may be provided with a coil spring configured to urge the slide 120 inward in the radial direction. With this configuration, the positioning device 100 according to the embodiment can automatically move the plurality of claws 130 inward in the radial direction by effect of a biasing force of the coil spring, and hold the outer circumferential portion of the analog meter 200 by the plurality of claws 130, even if an operator does not rotate the operating knob 144.

In the present specification, the term “substantially circular” in “substantially circular and transparent cover” is not limited to a completely circular shape, and may include projections, irregularities, cutouts, or the like, in a part of the circle shape. That is, the “cover” only needs to have a shape in which “positioning device” can position “sensor” at the center of the “cover”.

According to the positioning device according to the embodiment, a sensor can be readily positioned at the center of a cover included in analog meters of a plurality of types having different outer diameters.

What is claimed is:

1. A positioning device configured to position a sensor at a center of a surface of a substantially circular and transparent cover that covers a display surface of an analog meter, the positioning device comprising:
a body to be disposed to face the surface of the cover upon positioning the sensor;
a plurality of slides that are provided, in the body, to be movable in different directions along a radial direction of the cover;
a plurality of claws that are provided at tips of the plurality of slides and configured to hold an outer circumferential surface of the analog meter;
a synchronizing driver that is configured to move the plurality of slides in the radial direction in synchronization with each other such that distances of the plurality of claws from a center of the body are always equal to each other;
a sensor holder that is provided at a center of a surface of the body facing the surface of the cover, and configured to hold the sensor; and
a pusher configured to push the sensor held by the sensor holder toward the center of the surface of the cover facing the sensor.

2. The positioning device according to claim 1, wherein
for each of the plurality of slides, a rack formed along a moving direction of a corresponding slide of the plurality of slides is included at the corresponding slide, and
the synchronizing driver includes
a driving gear that is provided at the center of the body to be rotatable, and
a plurality of driven gears that are provided around the driving gear for corresponding slides of the plurality of slides, and are configured to rotate by rotation of the driving gear and directly or indirectly drive the rack of each of the plurality of slides, thereby moving each of the plurality of slides in the radial direction.

3. The positioning device according to claim 2, wherein
the synchronizing driver includes an operating knob that is configured to be rotated by an operator to drive the driving gear.

4. The positioning device according to claim 1, wherein
the plurality of slides are provided to cross each other at positions at which the plurality of slides overlap with the center of the body in a plan view.

5. The positioning device according to claim 4, wherein
the plurality of slides are provided at different positions in a direction that is orthogonal to the surface of the cover.

6. The positioning device according to claim 5, wherein
for each of the plurality of slides, a slit formed in a straight line along a moving direction of a corresponding slide of the plurality of slides is included in the corresponding slide, and
the pusher is inserted through the slit.

7. The positioning device according to claim 6, wherein
the body includes a pin,
the pin is disposed in the slit of each of the plurality of slides, and
the pin contacts an end of the slit in response to moving of each of the plurality of slides in the radial direction in a maximum amount, thereby stopping each of the plurality of slides from falling out of the body.

8. The positioning device according to claim 1, wherein
the body includes
a base that is provided at a center area of the body in a plan view, and
a guide that extends from the base in the radial direction, and is configured to guide a movement of each of the plurality of slides in the radial direction.

9. The positioning device according to claim 8, wherein
the guide includes a pair of walls extending from the base in the radial direction, and
the guide is configured to receive each of the plurality of slides between the pair of walls, and guide the movement of each of the plurality of slides in the radial direction.

10. The positioning device according to claim 9, wherein
the pair of walls each include a support groove extending in the radial direction and supporting a widthwise end of each of the plurality of slides.

11. The positioning device according to claim 1, wherein
the sensor holder includes a plurality of claws that form a snap-fit structure, and
the sensor holder is configured to hold the sensor by the plurality of claws that form the snap-fit structure.

12. The positioning device according to claim 1, wherein
the body includes a groove in the surface of the body facing the surface of the cover, and
a cable included in the sensor held by the sensor holder is fitted into the groove, and drawn outward of the body in the groove.
